(19) United States
(12) Patent Application Publication
(10) Pub. No.: US 2017/0321766 A1
(43) Pub. Date: Nov. 9, 2017

(54) METHOD FOR DETERMINING AND/OR CONTROLLING A POSITION OF AN ELECTRIC MOTOR

(71) Applicant: SCHAEFFLER TECHNOLOGIES AG & CO. KG, Herzogenaurach (DE)

(72) Inventor: Markus Dietrich, Oberkirch (DE)

(21) Appl. No.: 14/443,556

(22) PCT Filed: Nov. 4, 2013
(86) PCT No.: PCT/DE2013/200268

§ 371 Date: May 18, 2015

(30) Foreign Application Priority Data
Nov. 22, 2012 (DE) 10 2012 221 372.4
Dec. 19, 2012 (DE) 10 2012 223 738.0

(51) Int. Cl. F16D 48/06

(52) U.S. Cl. CPC F16D 48/064; F16D 2500/7109; F16D 2500/1024; F16D 2500/10412; F16D 2500/7041

(57) ABSTRACT

The invention relates to a method for determining and/or controlling a position of an electric motor, in particular in a clutch actuation system of a motor vehicle, wherein the position of a rotor of the electric motor is picked up by a sensor system situated on a stator of the electric motor outside an axis of rotation of the electric motor, and the position signal picked up by the sensor system is analyzed by an analysis unit. In a method in which the rotor position is detected with a high level of certainty, the position signal is transmitted to the analysis unit depending on a transmission distance between the sensor system and the analysis unit by means of an SPI protocol signal for short transmission distances, and/or by means of a PWM signal for longer transmission distances.

### CROSS-REFERENCE TO RELATED APPLICATIONS

The present application is the U.S. national stage application pursuant to 35 U.S.C. §371 of International Application No. PCT/DE2013/200268, filed Nov. 4, 2013, which application claims priority from German Patent Application Nos. DE 10 2012 221 372.4, filed Nov. 22, 2012, and DE 10 2012 223 738.0, filed Dec. 19, 2012, which applications are incorporated herein by reference in their entireties.

### TECHNICAL FIELD

The invention relates to a method for determining and/or controlling a position of an electric motor, in particular in a clutch actuation system of a motor vehicle, wherein the position of a rotor of the electric motor is picked up by a sensor system situated on a stator of the electric motor outside an axis of rotation of the electric motor, and the position signal picked up by the sensor system is analyzed by an analysis unit.

### BACKGROUND

In modern motor vehicles, in particular passenger cars, automated clutches, such as those described in DE 10 2011 014 936 A1, are being used to an increasing degree. The use of such clutches has the benefit of improved driving comfort, and has the result that it is more often possible to drive in gears with a high gear ratio. The clutches used here are utilized in hydraulic clutch systems, in which an electrohydraulic actuator, which is driven by an electrically commutated motor, is connected to the clutch by means of a hydraulic line.

In particular with electric motors in which the sensors are situated outside the axis of rotation of the electric motor, high position resolution is necessary. In this case, a magnetic transmitter ring is non-rotatably connected to the rotor of the electric motor, for example on a shaft end (on-axis), while the sensor system that senses the magnetic transmitter ring is attached, for example, to the stator (off-axis). The position of the sensor system does not change. The rotor of the electric motor has a limited number of pairs of poles, from which a specified number of flanks of the magnetic field switch are used to determine the position.

It is known that with small diameters of the magnetic transmitter ring situated on the rotor, in practice a two-pole magnet is used as the circular ring, which enables the position of the rotor to be reliably resolved electrically to 360° by the analysis unit. With regard to the diameter of the magnetic transmitter ring, it is limited however, since the curvature of the magnetic field over the pair of poles is not always adequate to obtain sufficient resolution of the sensor signal picked up by the sensors.

The use of multiple sensors is also known, for example with 5 sensors (3 switching Hall sensors and 2 analog Hall sensors) being used in practice. This requires considerable construction space in the clutch, however, and is an expensive solution.

Thus there exists a long felt need for a method for determining and controlling a position of an electric motor in a clutch actuation system of a motor vehicle wherein the position of a rotor of the electric motor is picked up by a sensor system situated on a stator of the electric motor outside an axis of rotation of the electric motor.

### SUMMARY

The object of the invention is therefore to specify a method for determining and/or controlling a position of an electric motor, in particular in a clutch actuation system, wherein the position of the rotor is detected with a high level of certainty despite the simple construction.

According to the invention, the object is fulfilled by the fact that the position signal is transmitted to the analysis unit depending on a transmission distance between the sensor system and the analysis unit by means of an serial peripheral interface (SPI) protocol signal for short transmission distances, and/or by means of a pulse width modulation (PWM) signal for longer transmission distances. This has the benefit that the position signal is transmitted via a digital signal. Although highly precise, the SPI protocol signal is also susceptible to interference, so for longer transmission distances the position signal is transmitted by means of a PWM signal. Thus with only one sensor system in use as a consequence of the existing installation conditions in the automated clutch, it can be decided which mode of transmission will be used. This is particularly cost-effective when a microprocessor is used in the analysis unit which permits both the analysis of an SPI protocol signal and the analysis of a PWM signal, meaning that only one electrical component is needed in order to satisfy both conditions.

Beneficially, when the electric motor is started an absolute position of the electric motor is transmitted by the sensor system via the SPI protocol signal or the PWM signal to the analysis unit, whereupon the electric motor is then supplied with current via a commutation derived by the analysis unit from an incremental position of the rotor unit. The transmission of the absolute position of the rotor via the SPI protocol signal or the PWM signal is then conducted very precisely in both cases. Once this absolute position has been ascertained, the position information needed for the motor commutation is transmitted via an incremental interface, in which the flanks issued by the sensor system, which are caused by the change of poles of the rotating magnetic transmitter ring, are counted. Such a procedure includes a short signal travel time, and is very precise.

In one design, a pulse to no-pulse ratio of the PWM signal is analyzed to transmit the absolute position of a pole pair of the rotor of the electric motor. The PWM signal is not sensitive to external influences of interference, particularly at a greater distance between the sensor system and the analysis unit, and permits an exact determination of the absolute position by analyzing the pulse to no-pulse ratio in the analysis unit.

In one variant, a comparison is performed between an incremental position of the rotor calculated by the analysis unit and the absolute position of the pole pair. The purpose of this comparison is to increase confidence in the calculated position information, and to detect transmission errors or calculation errors. The comparison of the absolute position and incremental position makes it possible to reliably validate the plausibility of the position signal.

Advantageously, the comparison is carried out cyclically, so that during operation of the electric motor there is always assurance that the commutated actuation of the electric motor also occurs at the right moment.

In a refinement, a small-diameter electric transmitter ring fastened to the rotor of the electric motor which has only one pole pair is used to determine the position of the rotor. The use of the small magnetic transmitter ring with two diametric magnetic poles allows reliable analysis of only one electrical period.

Alternatively, the magnetic transmitter ring having a larger diameter and a plurality of pole pairs, fastened to the rotor of the electric motor, is used to determine the position of the rotor, where the number of pole pairs of the magnetic transmitter ring is equal to the number of pole pairs of the rotor. That ensures that the sensor signal delivered by the sensor system is always clearly within one electrical period. Such a sensor signal can be used for the position information for commutation of the motor, since it is absolutely usable electrically through 360°.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a schematic view of a clutch actuation system of the present invention;

FIG. 2 is a schematic view of transmission of an output signal from the sensor system to an analysis unit;

FIG. 3 is a perspective view of a magnetic transmitter ring;

FIG. 4 is a first embodiment of a magnetic transmitter ring having a first ring diameter; and,

FIG. 5 a second embodiment of a magnetic transmitter ring having a second ring diameter.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It, is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

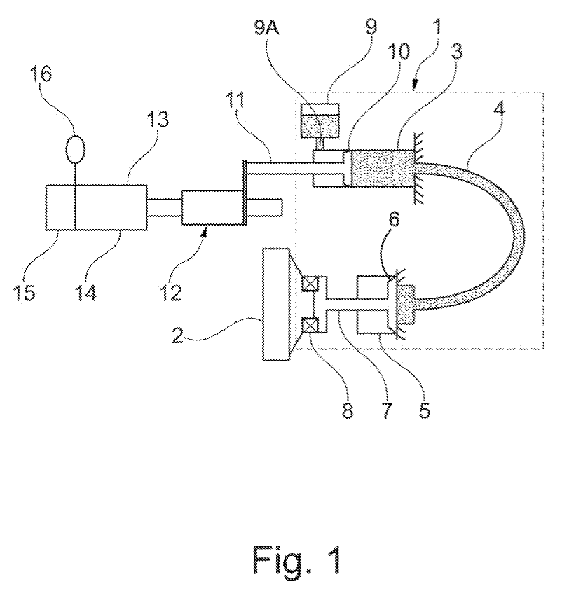

FIG. 1 depicts in simplified form clutch actuating system 1 for an automated clutch. Clutch actuating system 1 is assigned to friction clutch 2 in a drivetrain of a motor vehicle, and includes master cylinder 3, which is connected to slave cylinder 5 via hydraulic line 4, also referred to as a pressure line. Movable axially in slave cylinder 5 is slave piston 6, which actuates friction clutch 2, by means of actuating organ 7 and with bearing 8 interposed. Master cylinder 3 is connected to equalizing container 9 through connecting aperture 9A. Master piston 10 is movable in master cylinder 3. Piston rod 11, which is movable linearly in the longitudinal direction together with master piston 10, extends from master piston 10. Piston rod 11 of master cylinder 3 is coupled by means of threaded spindle 12 with positioner 13 operated by an electric motor. The electric-motor-operated positioner 13 includes electric motor 14 designed as a commutated DC motor and analysis unit 15. Threaded spindle 12 converts a rotary motion of electric motor 14 to a longitudinal motion of piston rod 11 or of master cylinder piston 10. Friction clutch 2 is actuated automatically by electric motor 14, threaded spindle 12, master cylinder 3 and slave cylinder 5.

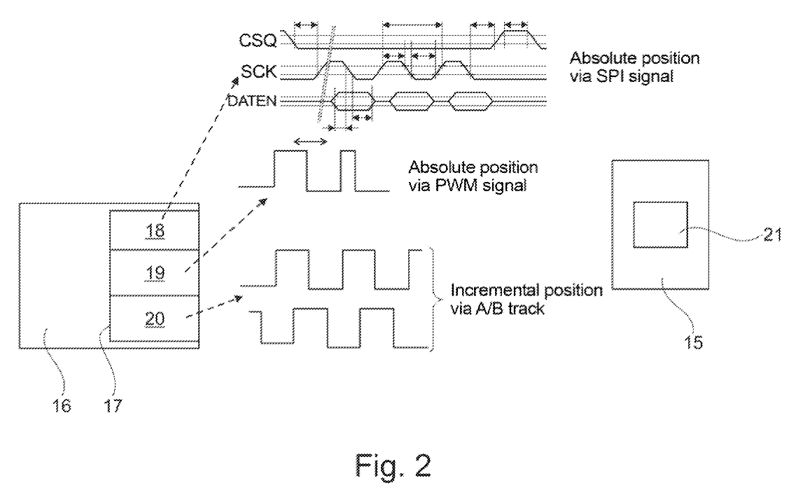

Integrated onto or into electric-motor-operated positioner 13 is sensor system 16, as depicted in FIG. 2. Sensor system 16 is spatially separated from analysis unit 15. Thus sensor system 16 can be situated, for example, in a transmission bell, while analysis unit 15 is positioned outside of the transmission bell. Situated inside sensor system 16 is signal conditioning circuit 17, which has SPI interface 18 and/or PWM interface 19. In addition, signal conditioning circuit 17 includes incremental interface 20.

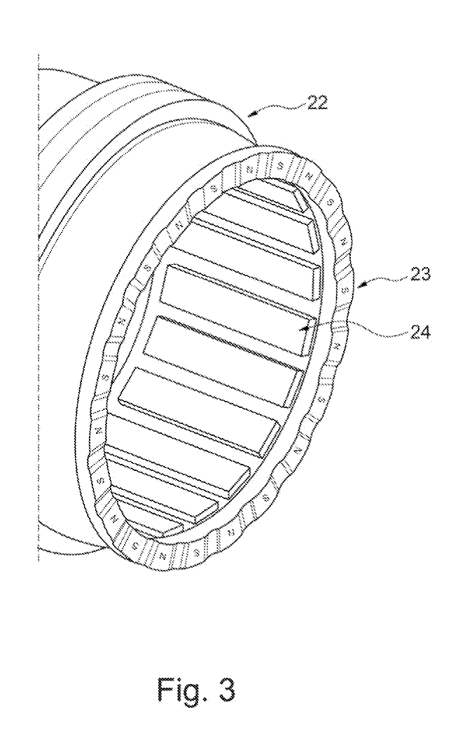

FIG. 3 shows rotor 22 of electric motor 14, which is designed as a hollow shaft. Rotor 22 of commutated electric motor 14 (not shown in further detail) has, on a side facing toward sensor system 16, which is positioned on the stator (not shown in further detail), magnetic transmitter ring 23, which includes a specified number of N, S magnetic poles. Rotor magnets 24 are fastened within rotor 23, rotor magnets 24 having the same number of N, S pole pairs as magnetic transmitter ring 23. An N, S pole pair is made up here of two N, S magnetic poles, whose directions of magnetization run in opposite directions. Such an off-axis system operates with very high resolution and precision, and is able to permit rapid and reliable data transmission through the use of a standard sensor system.

When turning on electric motor 14, first the absolute position of rotor 22 of electric motor 14 is determined. The absolute position sensed in a N, S pole pair is transmitted via PWM interface 19 or SPI interface 18. The selection between SRI interface 18 and PWM interface 19 is made depending on the distance between sensor system 16 and analysis unit 15. The SPI protocol signal is always used to transmit the absolute position of rotor 22 if only short transmission distances have to be surmounted between sensor system 16 and analysis unit 15. But if the distance between sensor system 16 and analysis unit 15 is greater, the absolute position is transmitted by means of the digital PWM signal. Such a PWM signal has the advantage of not being susceptible to interference acting on the output signal of sensor system 16 along the transmission path. Advantageously, the absolute position is ascertained by analysis unit 15 from the pulse to no-pulse ratio of the PWM signal.

If the absolute position in the electrical period is known, the electrification and actuation of electric motor 14 begins. From this moment on, the rotor position is transmitted with incremental information, which is issued via incremental interface 20 of sensor system 16. Within analysis unit 15, the position of rotor 22 of electric motor 14 is calculated from the incremental information, based on the absolute position of a pole pair. In the present example, a fast incremental sensor, for example a giant magnetoresistance (GMR) sensor, is used in sensor system 16 to ascertain the position of rotor 22. The output signal of incremental interface 20 of sensor system 16 is preferably transmitted via an A/B signal track. Signal tracks A, B are electrically phase-shifted by 90° relative to each other, which corresponds to half a pulse. The use of these two signal tracks has the advantage that interference in the signal transmission path is avoided, or should interference occur, a plausibility check of the output signal from sensor system 16 is possible. Furthermore, the direction of motion of rotor 22 can be detected simply in this way. The incremental position of rotor 22 transmitted via the A/B track is likewise read in analysis unit 15 directly into the inputs of microprocessor 21, which is positioned in analysis unit 15, and which counts the flanks of the output signal of each signal track A, B. Every interrupt triggers a block commutation, where the number of interrupts depends on the number of pulses delivered by sensor system 16 per commutation step.

So as to increase confidence in the calculated position information, and to detect any transmission and/or computing errors, a comparison of the incremental position of rotor 22 calculated in analysis unit 15 to the absolute position of electric motor 14 in the pole pair, as ascertained at the beginning of operation of electric motor 14, is performed cyclically.

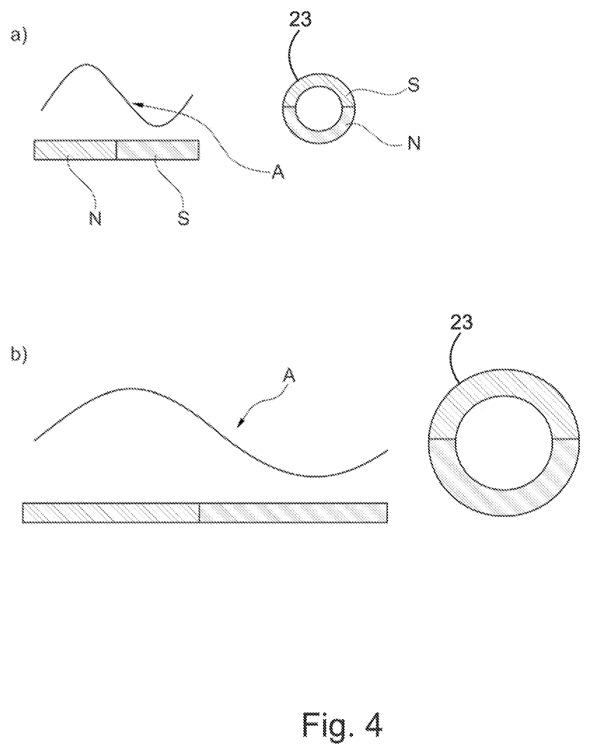

It is significant for the proposed method that the output signal A issued from sensor system 16 is always unambiguous within one electrical period. Two methods for realizing this are proposed. FIG. 4 shows magnetic transmitter ring 23 with a small ring diameter. Such a magnetic transmitter ring 23 is also known as a diametric-magnetic tray, and has only one pole pair consisting of one south pole S and one north pole N (FIG. 4a). The GMR sensor contained in sensor system 16 delivers via this pole pair a signal which is electrically unambiguous through 360°. This is particularly recognizable in the signal course of the output signal A issued by the sensor system, which has a sufficiently noticeable gradient which can be readily analyzed. But if the diameter of magnetic transmitter ring 23 is enlarged, the use of only one pole pair results in a course of the output signal A of sensor system 16 which has a flattened signal course, which cannot be analyzed with sufficient precision by analysis unit 15 (FIG. 4b).

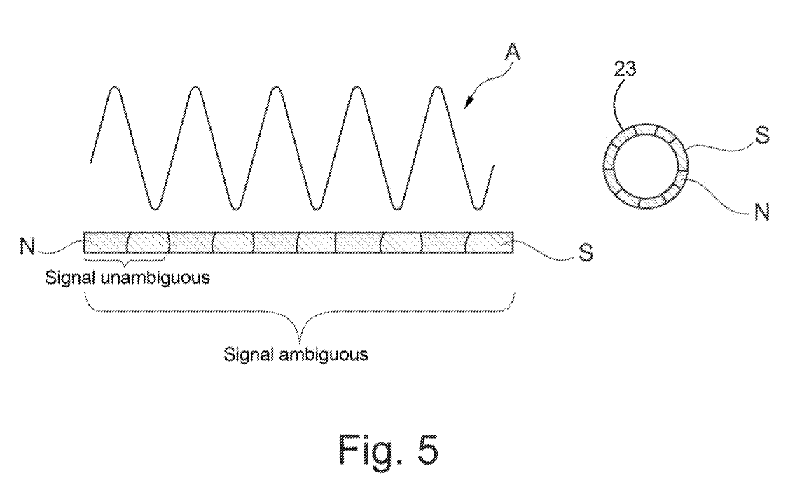

If, as depicted in FIG. 5, the diameter of magnetic transmitter ring 23 is enlarged, and if a variety of pole pairs are distributed alternately around magnetic transmitter ring 23, this guarantees that the output signal A from sensor system 16 also remains clearly within one electrical period of 360° with such a multi-pole sensor, if magnetic transmitter ring 23 has exactly as many pole pairs as rotor 22.

In view of the explanations given, an off-axis sensor system is presented which has short signal transit times, in order to use position information for commutating electric motor 14. At the same time, the output signal A from sensor system 16 is electrically unambiguous through 360°. Through the use of a PWM signal to determine the absolute position, in particular the analysis of the pulse to no-pulse ratio of this PWM signal, a precise determination of the absolute position of electrical motor 14 at its start is possible. At the same time, interference-proof transmission between sensor system 16 and analysis unit 15 free of external interference signals is realized. Furthermore, plausibility checking of the calculated incremental position against the absolute position in a pole pair is possible at any time. Thus, an off-axis electric motor is presented which is simple to construct, and whose rotor position is detected with a high level of certainty.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMBERS

1 clutch actuating system
2 friction clutch
3 master cylinder
4 hydraulic line
5 slave cylinder
6 slave piston
7 actuating organ
8 clutch release bearing
9 equalizing container
9A aperture
10 master piston
11 piston rod
12 threaded spindle
13 positioner
14 electric motor
15 analysis unit
16 sensor system
17 signal conditioning circuit
18 SPI interface
19 PWM interface
20 incremental interface
21 microprocessor
22 rotor
23 magnetic transmitter ring
24 rotor magnet
N north pole
S south pole
A output signal

What is claimed is:

1-7: (canceled)

8: A method of determining and controlling a position of an electric motor in a clutch actuation system of a motor vehicle, comprising:
arranging a stator of the electric motor outside an axis of rotation of the electric motor;
detecting the position of a rotor of the electric motor by a sensor system;
transferring a position signal from the sensor system to an analysis unit; and,
analyzing the position signal from the sensor system by the analysis unit,
wherein when the transmission distance between the sensor system and the analysis unit is a first transmission distance, the position signal is transmitted by a serial peripheral interface protocol signal, and when the transmission distance between the sensor system and the analysis unit is a second transmission distance, the position signal is transmitted by a pulse width modulation signal.

9: The method of claim 8, wherein an absolute position of the electric motor is transmitted by the sensor system via the serial peripheral interface protocol signal or the pulse width modulation signal to the analysis unit when the electric motor is started, whereupon the electric motor is then supplied with current via a commutation derived by the analysis unit from an incremental position of the rotor of the electric motor.

10: The method of claim 9, wherein a pulse to no-pulse ratio of the pulse width modulation signal is analyzed to transmit the absolute position of a pole pair of the rotor of the electric motor.

11: The method of claim 9, wherein a comparison is carried out between an incremental position of the rotor calculated by the analysis unit and the absolute position of the pole pair.

12: The method of claim 11, the comparison is carries out cyclically.

13: The method of claim 8, wherein a small-diameter magnetic transmitter ring fastened to the rotor of the electric motor which has only one pole pair is used to determine the position of the rotor.

14: The method of claim 13, wherein the magnetic transmitter ring having a larger diameter and a plurality of pole pairs, fastened to the rotor of the electric motor, is used to determine the position of the rotor, where the number of pole pairs of the magnetic transmitter ring is equal to the number of pole pairs of the rotor.
